(19) United States
(12) Patent Application Publication
(10) Pub. No.: US 2010/0295957 A1
(43) Pub. Date: Nov. 25, 2010

(54) METHOD OF CAPTURING DIGITAL IMAGES AND IMAGE CAPTURING APPARATUS

(75) Inventor: Bo Larsson, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/468,480

(22) Filed: May 19, 2009

(51) Int. Cl. H04N 5/228; H04N 7/26

(52) U.S. Cl. 348/222.1; 375/240.16; 375/E07.123

(57) ABSTRACT

A method of capturing digital images is disclosed. The method comprises registering an image projected on an image sensor; determining motions present in the image; determining a metric representing an amount of the motions; and storing the registered image with associated meta data comprising the metric. Further, image capturing apparatus is disclosed, comprising an image sensor; optics arranged to project an image on the image sensor; a signal processor arranged to receive signals provided by the image sensor, to determine motions present in the image, and to determine a metric representing an amount of the motions; and a memory arranged to store a registered image with associated meta data comprising the metric.

### TECHNICAL FIELD

The present invention relates to a method of capturing digital images, and image capturing apparatus. In particular, the invention relates to determination of motions present in an image, and storing an indication of the motions associate with the image.

### BACKGROUND

An increasing amount of multimedia content in apparatuses, such as mobile telephones with camera capabilities or digital cameras, gives an increased desire to assign proper metadata to the pieces of content for facilitating management of the multimedia content.

Metadata has traditionally been information about creator, naming of content, date, number, etc. Within imaging, data such as light sensitivity settings, shutter speed, time, date, and manually entered text tags has been present. However, as a picture is captured, there are other circumstances that may be of importance for managing a stock of images, which may be too trying to describe in e.g. the text tag. Therefore, there is a desire to provide at least some such circumstances automatically into the metadata.

### SUMMARY

The present invention is based on the understanding that during the capturing of an image, information can be collected about activity in the scene. This information can be stored as metadata, which for example can be utilised during rendering of the image to enhance the expression of the image.

According to a first aspect, there is provided a method of capturing digital images. The method comprises registering an image projected on an image sensor; determining motions present in the image; determining a metric representing an amount of the motions; and storing the registered image with associated meta data comprising the metric.

The meta data may be stored in a meta data field of the file of the registered image, in a meta data file separate from the file of the registered image, or in a database with an index associating the meta data to the file of the registered image.

The determining of motions may comprise capturing at least two frames of pictures separate in time; providing the frames to a video encoder; and receiving present motions from the video encoder as vectors.

The determining of motions may comprise capturing at least two frames of pictures separate in time; and determining a shift between one of the frames to another, wherein the motions are described by the at least one vector based on the shift.

The determining of the metric may comprise analyzing the at least one vector; and assigning a metric based on the vector analysis. The analysis may provide at least two vectors, and the analyzing of the at least two vectors may comprise averaging of the size of the vectors. The analyzing of the vectors may comprise normalising the vectors by a theoretical maximum of vectors to represent motions in the image. The analyzing of the at least one vector may comprise filtering of the vectors. The analyzing of the at least one vector may comprise compensating for global motions of the image.

The determining of motions and determining the metric may be performed by recording a video clip; determining the motions and metric; and deleting the video clip.

The determining of motions may be performed during a period where an autofocus function of optics projecting the image to the image sensor is operating.

The determining of motions may be performed on a reduced resolution image compared to the registered image.

According to a second aspect, there is provided an image capturing apparatus comprising an image sensor; optics arranged to project an image on the image sensor; a signal processor arranged to receive signals provided by the image sensor, to determine motions present in the image, and to determine a metric representing an amount of the motions; and a memory arranged to store a registered image with associated meta data comprising the metric.

The apparatus may be arranged to store the meta data in a meta data field of the file of the registered image, in a meta data file separate from the file of the registered image, or in a database with an index associating the meta data to the file of the registered image.

The signal processor may comprise a video encoder arranged to receive at least two frames of pictures separate in time and to provide present motions as vectors. The signal processor may further comprise a vector processing mechanism arranged to provide an average of the size of the vectors, filter the vectors, normalise the vectors, or compensate for global motions of the image, or any combination thereof, wherein the metric is determined from an output of the vector processing mechanism.

The optics projecting the image to the image sensor may comprise an autofocus function, and a control signal may be provided when the autofocus function is operating wherein the determining of motions is arranged to be performed during a period when the control signal indicates operation of the autofocus function.

### BRIEF DESCRIPTION OF DRAWINGS

FIG. 1 is a flow chart illustrating a method according to an embodiment.

FIG. 2 schematically illustrates an apparatus according to an embodiment.

FIG. 3 schematically illustrates a computer readable medium according to an embodiment.

FIG. 4 is a block diagram illustrating a signal processor according to an embodiment.

FIG. 5 is a flow chart illustrating a procedure for determining activity according to an embodiment.

### DETAILED DESCRIPTION

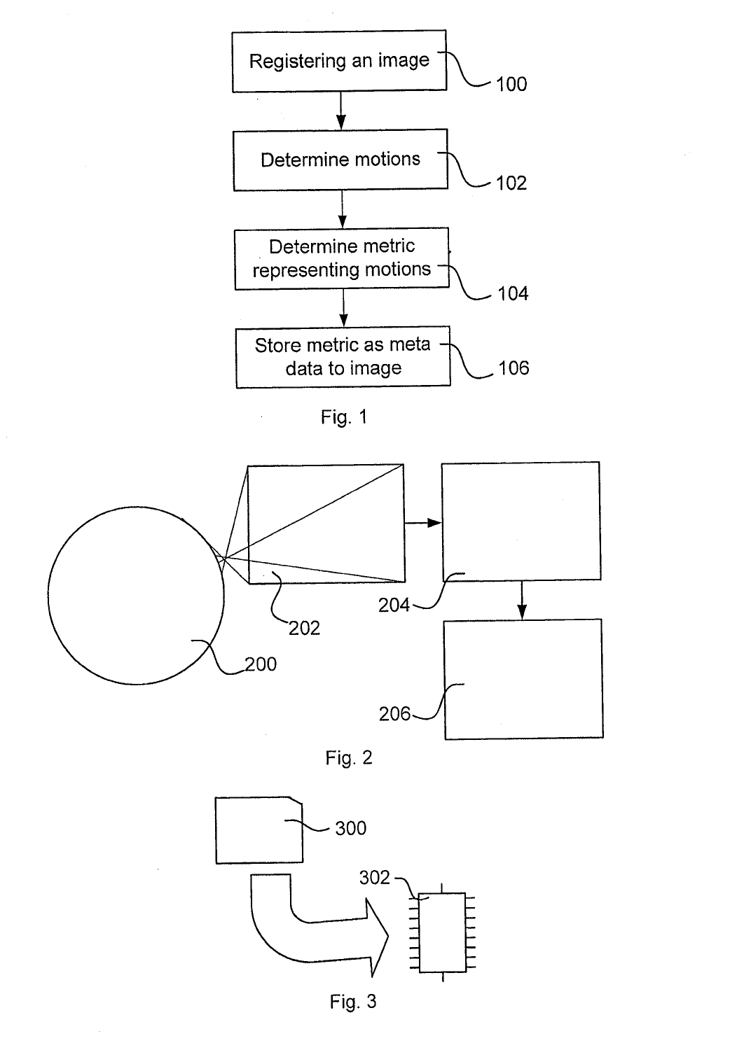

FIG. 1 is a flow chart illustrating a method according to an embodiment. In an image registration step 100, an image projected towards an image sensor by optics is registered, and electrical signals are provided by the sensor. These signals can then be processed for storing a picture, but also for determining activity present in the imaged scene. Thus, in a motion determination step 102, activity, i.e. motions present in the imaged scene, is determined. The motions can be determined by capturing at least two frames of pictures separated in time. The frames can then be processed by a video encoder, or any processor enabled to provide similar calculations. The video encoder can then provide a representation of the motions as vectors. As an alternative view of the provision of such vectors, any mechanism provided by at least two frames of pictures can determine a shift between the frames and describe any shift as one or more vectors. This can be performed in a processor, which abilities can be separate or integrated with other functions of the image capturing apparatus.

Here, as a rule of thumb, for economy versions, all processing can be made in the same processor that is handling other applications of the apparatus. Often, in such a case, the size of the image and performance may be limited by the shared performance of the application processor. In more sophisticated versions, a video encoder is provided, and the approach described above can be utilized. Thus, the processing capability may not need to be shared with other applications, an performance and capability is increased. For even more sophisticated versions, multiple video encoders can be utilized, and the image sensor itself can also comprise some processing. In those cases, even small details in the images can be considered for determination of motions, and a high granularity of representation of activity is enabled.

The determination of shift can be based on block matching algorithms wherein it is determined the amount of changed/unchanged blocks between the frames. Alternatively, the determination of shift can be based on other division of the image into parts, e.g. by recognizing objects and their shifts between the images, or be based on a complex analysis of the aggregate representation of the content of the image An example of a practical approach is to capture a short video sequence, i.e. a video clip, at the time of capturing the picture. From the video clip, motions and metric are determined according to the video encoder approach demonstrated above, and then the video clip is erased. Another example of practical implementation is to perform the motion determination on reduced resolution images compared to the registered and stored image. Further an example of practical implementation is to activate the motion determination during a period where an autofocus mechanism of the optics is activated. Any combination of these practical implementations is of course further advantageous.

For provision of a representation of activity that can be properly used, e.g. at rendering of the picture, a proper metric representing the motions is determined in a metric determination step 104. The metric can be determined by analyzing the vectors, and then based on the analysis assigning a metric. The analyzing can comprise averaging of the vectors to form the metric. Filtering and/or normalizing of the vectors can be made to get a proper representation. The normalising of the vectors is preferably done in view of a theoretical maximum of vectors to represent motions in the image. Thus, considering a case with a single large motion compared to a case with many smaller motions, especially when application of averaging, normalisation may then give a more representative metric of the motion of the scene. The theoretical maximum of vectors can be determined from the video encoder in use, or from a capability limit of the processing means.

Compensation for global motions, i.e. where all of the image is moving the same way during capturing, e.g. because of it being hard to keep the camera steady when shooting the picture, can be provided to get a representation of true motion in sense of the expression of the picture, and not a representation of a shaky hand.

When the metric is determined, it is stored as metadata to the image in a metadata storing step 106. The metadata can be stored in a data field of the stored image, in a separate metadata file together with the image file, or be stored in a meta data database with an index associating it with the image file.

FIG. 2 schematically illustrates an apparatus according to an embodiment. The apparatus comprises optics 200 arranged to project an image on an image sensor 202. The image sensor 202 provides an electrical representation of the projected image, here for the sake of simplicity also called “the image” in the discussion of its further processing, to a signal processor 204 or processing means. The representation is preferably a digital representation. The signal processor 204 is arranged to receive the signals and to determine motions present in the scene of the image. From those determined motions, the signal processor 204 determines a metric representing an amount of the motions by calculations in line with the examples demonstrated above with reference to FIG. 1. As an alternative, or in addition to calculations, look-up tables can be used for some operations. Metrics for the motions are determined and being assigned as metadata to the image to be stored. The metadata is stored in a memory 206. As discussed above, the image and the metadata can be stored in one file or as separate files in one memory, or be stored as separate files in separate memories. An association by an index between image file and metadata file is a feasible approach.

FIG. 3 schematically illustrates a computer readable medium according to an embodiment. The methods according to the present invention are suitable for implementation with aid of processing means, such as one or more signal processors and/or video encoders. A signal processor or video encoder may be embodied as a single signal processing unit or a number of signal processing units. Therefore, there is provided computer programs, comprising instructions arranged to cause the processing means to perform the steps of any of the method according to any of the embodiments described with reference to FIG. 1, in any of the embodiments of the apparatus described with reference to FIG. 2. The computer programs preferably comprises program code which is stored on a computer readable medium 300, which can be loaded and executed by a processing means 302 to cause it to perform the method, respectively, according to embodiments. The computer 302 and computer program product 300 can be arranged to execute the program code where actions of the any of the methods are performed, or be performed on a real-time basis, where actions are taken upon need and availability of needed input data. The processing means 302 is preferably what normally is referred to as an embedded system. Thus, the depicted computer readable medium 300 and computer 302 in FIG. 3 should be construed to be for illustrative purposes only to provide understanding of the principle, and not to be construed as any direct illustration of the elements.

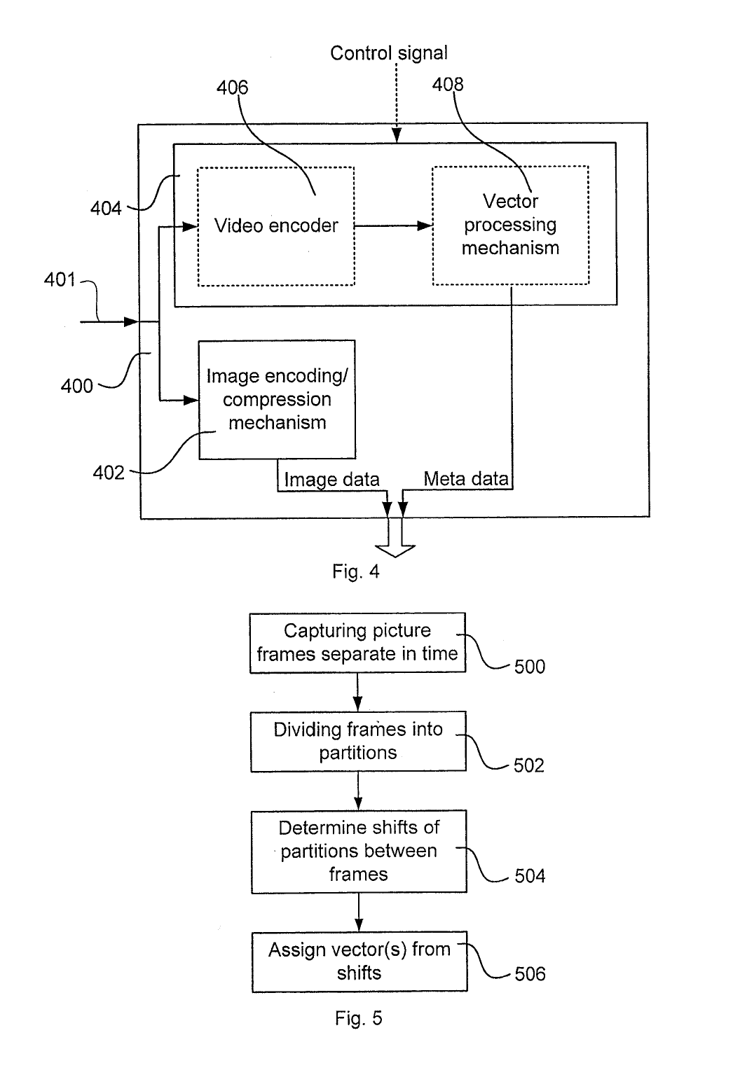

FIG. 4 is a block diagram illustrating an image processor 400 according to an embodiment. The image processor receives image signals 401 from an image sensor. The image processor 400 comprises an image encoding and/or compression mechanism 402 which forms the image data to be stored from the received signals. The image processor 400 also comprises an activity determination mechanism 404 which also receives the signals from the image sensor. The activity determination mechanism 404 determines motions present in the scene of the image at capturing and determines a metric of the motions, which then is provided as metadata to be stored together or associated with the image data. The activity determination mechanism 404 can comprise, but is not limited to, a video encoder 406 or any processor enabled to provide similar calculations which determines vectors representing motions in the scene. The vectors can be provided to a vector processing mechanism 408 of the activity determination mechanism 404. The vector processing mechanism 408 processes the vectors to provide the metric. The vector processing can comprise filtering, averaging, normalization, global compensation, etc. as described with reference to FIG. 1 to provide a proper metric. The activity determination mechanism 404 can receive a control signal which indicates a proper time period for activity determination. The control signal can for example be provided by an autofocus function of the camera.

FIG. 5 is a flow chart illustrating a procedure for determining activity according to an embodiment. In an image capturing step 500, frames are captured slightly separated in time. From the frames, shift in the scene of the frames is to be used for determining present motions, as described above. This can be performed by dividing the frames into partitions, e.g. blocks or determined image objects, in a partition division step 502. For each, or at least a manageable amount, with regard to processing capability, of the partitions, a shift is determined in a shift determination step 504. From the determined shifts, vectors are assigned in a vector assignment step 506.

As discussed above, the provision of vectors can be made in other ways as well. Video encoding models is a feasible way, as such models often provide a vector based representation. Other models that are not vector based can also be used, where amount of motion is determined from other parameters provided by video encoding approaches arranged to provide reduced bit rate representation of dynamic scenes.

1. A method of capturing digital images, comprising registering an image projected on an image sensor;
determining motions present in the image;
determining a metric representing an amount of the motions; and
storing the registered image with associated meta data comprising the metric.

2. The method according to claim 1, wherein the meta data is stored in a meta data field of the file of the registered image, in a meta data file separate from the file of the registered image, or in a database with an index associating the meta data to the file of the registered image.

3. The method according to claim 1, wherein the determining of motions comprises
capturing at least two frames of pictures separate in time;
providing the frames to a video encoder; and
receiving present motions from the video encoder as vectors.

4. The method according to claim 1, wherein the determining of motions comprises
capturing at least two frames of pictures separate in time; and
determining a shift between one of the frames to another, wherein the motions are described by the at least one vector based on the shift.

5. The method according to claim 3, wherein the determining of the metric comprises
analyzing the at least one vector; and
assigning a metric based on the vector analysis.

6. The method according to claim 5, wherein the analysis provides at least two vectors, and the analyzing of the at least two vectors comprises averaging of the size of the vectors.

7. The method according to claim 5, wherein the analyzing of the vectors comprises normalizing the vectors by a theoretical maximum of vectors to represent motions in the image.

8. The method according to claim 5, wherein the analyzing of the at least one vector comprises filtering the vectors.

9. The method according to claim 5, wherein the analyzing of the at least one vector comprises compensating for global motions of the image.

10. The method according to claim 1, wherein the determining of motions and determining the metric is performed by
recording a video clip;
determining the motions and metric; and
deleting the video clip.

11. The method according to claim 1, wherein the determining of motions is performed during a period where an autofocus function of optics projecting the image to the image sensor is operating.

12. The method according to claim 1, wherein the determining of motions is performed on a reduced resolution image compared to the registered image.

13. An image capturing apparatus comprising
an image sensor;
optics arranged to project an image on the image sensor;
a signal processor arranged to receive signals provided by the image sensor, to determine motions present in the image, and to determine a metric representing an amount of the motions; and
a memory arranged to store a registered image with associated meta data comprising the metric.

14. The apparatus according to claim 13, arranged to store the meta data in a meta data field of the file of the registered image, in a meta data file separate from the file of the registered image, or in a database with an index associating the meta data to the file of the registered image.

15. The apparatus according to claim 13, wherein the signal processor comprises a video encoder arranged to receive at least two frames of pictures separate in time and to provide present motions as vectors.

16. The apparatus according to claim 15, wherein the signal processor further comprises a vector processing mechanism arranged to provide an average of the size of the vectors, filter the vectors, normalize the vectors, or compensate for global motions of the image, or any combination thereof, wherein the metric is determined from an output of the vector processing mechanism.

17. The apparatus according to claim 13, wherein the optics projecting the image to the image sensor comprises an autofocus function, and a control signal is provided when the autofocus function is operating wherein the determining of motions is arranged to be performed during a period when the control signal indicates operation of the autofocus function.
